(19) United States
(12) Patent Application Publication
(10) Pub. No.: US 2025/0153429 A1
(43) Pub. Date: May 15, 2025

(54) SYSTEMS AND METHODS FOR PRODUCING SMALL-SCALE MIXERS FOR DRUG MANUFACTURING

(71) Applicant: Regeneron Pharmaceuticals, Inc., Tarrytown, NY (US)

(72) Inventors: Wolfgang MUELLER, Montréal (CA); Gorgi PAVLOV, Bethlehem, PA (US); Amardeep Singh BHUPENDER BHALLA, Montvale, NJ (US)

(73) Assignee: Regeneron Pharmaceuticals, Inc., Tarrytown, NY (US)

(21) Appl. No.: 18/945,863

(22) Filed: Nov. 13, 2024

Related U.S. Application Data
(60) Provisional application No. 63/548,260, filed on Nov. 13, 2023.

(51) Int. Cl. B29C 64/188; B29C 64/118; B29L 31/00; B33Y 10/00; B33Y 30/00; B33Y 40/20

(52) U.S. Cl. CPC B29C 64/188; B33Y 30/00; B33Y 40/20; B29C 64/118; B29L 2031/748; B33Y 10/00

(57) ABSTRACT

Disclosed herein are systems and methods for producing a small-scale mixer based on an at-scale mixer that may be used for pharmaceutical product manufacturing. In particular, disclosed herein are methods that involve use of a three-dimensional printer to produce components of the small-scale mixer, a smoothing apparatus to smooth a surface of the small-scale mixer, and a fusing apparatus to fuse the components of the small scale-mixer to produce the small-scale mixer.

### CROSS-REFERENCE TO RELATED APPLICATIONS

This application claims priority to U.S. Provisional Patent Application No. 63/548,260 filed on Nov. 13, 2023, the entire disclosure of which is herein incorporated by reference.

### BACKGROUND

During manufacturing and formulation of a pharmaceutical product, mixing components is a necessary step. For example, excipients may be added to a drug substance in order to obtain a formulated drug product, which requires mixing any added excipients or solutions using a mixing device. However, mixing can introduce shear stresses that can adversely affect components of a formulation, in addition to presenting risks of adsorption and aggregation. These risks are particularly noteworthy when formulating biopharmaceutical products, which can include large molecules with specific three-dimensional structures that are vulnerable to unfolding, aggregation, or degradation. Improperly folded, aggregated or degraded biopharmaceutical products may reduce the efficacy of the drug product and increase risks of an undesirable immune response.

Therefore, characterization of shear stresses introduced by mixing processes, and characterization of the vulnerability of therapeutic proteins or other formulation components to shear stresses, may be useful to minimize risks such as degradation during process development. However, typical studies to determine the effects of shear stress on the stability of pharmaceutical products are often not economical. Large volumes of material, for example, a minimal fill volume of 10 L to 20 L, are required, and the materials needed for pharmaceutical products are expensive to procure. Furthermore, the timeline for completing these studies is generally very short.

Therefore, demand exists for methods and systems to address the challenges associated with implementing shear stress studies.

### SUMMARY

The present disclosure provides systems and methods for producing a small-scale mixer. The disclosed systems and methods for producing a small-scale mixer may be used to inform the manufacturing and formulation of a pharmaceutical product.

In an exemplary embodiment, the system for producing a small-scale mixer that replicates mixing operations of a second mixer includes at least one three-dimensional printer, configured to produce a first and second set of components with a respective first and second quality attribute of the small scale-mixer that replicate operation of corresponding components of the second mixer; at least one smoothing apparatus configured to smooth a surface of the components of the small-scale mixer produced by the at least one-three dimensional printer; and a fusing apparatus configured to fuse the smoothed components of the small-scale mixer to produce the small-scale mixer.

In one aspect, the at least one three-dimensional printer comprises a first three-dimensional printer and a second three-dimensional printer.

In one aspect, the respective first and second quality attribute of the small-scale mixer includes precision, size, density, surface roughness, and thickness.

In one aspect, the small-scale mixer has a fill volume of less than 100 L, less than 50 L, less than 10 L, less than 5 L, less than 3 L, less than 2 L, less than 1 L, between 0.1 and 2 L, or any size in between. In another aspect, the small-scale mixer has a fill volume of about 100 L, about 50 L, about 10 L, about 5 L, about 2 L, about 1.5 L, about 1 L, about 0.5 L or about 0.1 L, or any size in between.

In one aspect, the method further comprises a first computer system coupled to the at least one three-dimensional printer, the first computer system configured to store at least one three-dimensional model of the components of the small-scale mixer and to communicate the at least one three-dimensional model to the three-dimensional printers. In a specific aspect, the method further comprises a second computer system coupled to the first computer system, the second computer system configured to generate the at least one three-dimensional model. In a specific aspect, generating the at least one three-dimensional model uses a scaling factor relating a plurality of dimensions of the at least one three-dimensional model to a plurality of dimensions of a second mixer. In a specific aspect, the plurality of dimensions comprises impeller clearance off the bottom of the mixer, liquid level, tank diameter, baffle width, impeller diameter, hub diameter, blade width, blade height, and hub height. In a specific aspect, the second mixer can be a LevMixer® Single-Use Mixing Systems by Pall Life Sciences, a Flexsafe® Single-Use Mixing Systems by Sartorius, or a Mobius® Single-Use Mixing Systems by Merck KGaA. In one aspect, the second mixer has a fill volume of greater than 10 L, greater than 50 L, greater than 100 L, greater than 200 L, or greater than 500 L, greater than 1,000 L, greater than 2,000 L, greater than 5,000 L, greater than 10,000 L, or greater than 50,000 L, or any size in between. In another aspect, the second mixer has a fill volume of about 10 L, about 50 L, about 100 L, about 200 L, about 500 L, about 1,000 L, about 2,000 L, about 5,000 L, about 10,000 L, or about 50,000 L, or any size in between.

In one aspect, the first three-dimensional printer is configured to produce a shell of the small-scale mixer using a material selected from the group consisting of polycarbonate, acrylonitrile butadiene styrene, polylactic acid, polyethylene terephthalate (PET), nylon, metal, and glass/PET. In another aspect, the first three-dimensional printer is configured to use fusion deposition modeling. In a further aspect, the first three-dimensional printer is configured to eject material in liquid or semi-liquid form in order to deposit it in successive layers using a nozzle. In a further aspect, the nozzle has a diameter, or opening in the nozzle, of about 50 μm, about 100 μm, about 400 μm, or about 1000 μm, which, in some aspects, results in an extrusion width of about 50 μm, about 100 μm, about 400 μm, or about 1000 μm.

In one aspect, the second three-dimensional printer is configured to produce an impeller or components thereof of the small-scale mixer using a material selected from the group consisting of photosensitive resin, biocompatible resin with minimal leachables and extractables, and low absorption engineering resin. In a specific aspect, the photosensitive resin is dental resin. In a specific aspect, the impeller components include a bearing clip, pin restraint, top fin section, bottom hub of the impeller, and magnets. In one aspect, the second three-dimensional printer is configured to produce an impeller configured with magnet configurations. In another aspect, the second three-dimensional printer comprises an ultraviolet liquid crystal display screen. In a further aspect, the second three-dimensional printer is configured to print at a resolution in the x and y axes of about 5 μm, about 10 μm, about 20 μm, about 25 μm, about 30 μm, about 45 μm, about 50 μm, about 60 μm, about 70 μm, about 80 μm, about 90 μm or about 100 μm, or any length in between. In a further aspect, the second three-dimensional printer is configured to print at a resolution in the z axis that is about 0.05×, about 0.1×, about 0.2×, about 0.3×, about 0.4×, about 0.5×, about 0.6×, about 0.7×, about 0.8×, about 0.9×, about 1.0×, about 2.0×, about 3.0×, about 4.0×, about 5.0×, about 6.0×, about 7.0×, about 8.0×, about 9.0×, about 10.0×, or about 20.0× the resolution in the x and y axes, or any resolution in between.

In one aspect, the at least one smoothing apparatus is configured to smooth a surface of the components of the small-scale mixer using a material selected from the group consisting of photosensitive resin, biocompatible resin with minimal leachables and extractables, and low absorption engineering resin. In a specific aspect, the photosensitive resin is dental resin. In another aspect, the at least one smoothing apparatus is configured to smooth a surface of the small-scale mixer by curing at least one layer of the material coated on the surface. In a further aspect, the at least one smoothing apparatus comprises a handheld ultraviolet (UV) light, a curing chamber, or a photostability UV chamber.

In one aspect, the at least one smoothing apparatus is configured to chemically smooth the surface of the small-scale mixer using a volatile solvent bath. In another aspect, the at least one smoothing apparatus comprises chemically polishing the surface of the small-scale mixer using a volatile solvent. In another aspect, the at least one smoothing apparatus is configured to melt a material of the second mixer onto a surface of the small-scale mixer using a heat gun. In a further aspect, the material of the second mixer is a linear low density polyethylene.

In another aspect, that at least one smoothing apparatus comprises physical abrasion. In a further aspect, the physical abrasion can be sand paper, polishing paper, polishing powder, polishing paste, and/or sand blasting.

In one aspect, the fusing is performed by resin curing. In another aspect, the fusing apparatus is a handheld UV light, curing chamber, or a UV photostability chamber. In a further aspect, the at least one smoothing apparatus is the same apparatus as the fusing apparatus.

In another exemplary embodiment, a method for producing a small-scale mixer that replicates mixing operations of a second mixer comprises (a) selecting a fill volume for a small-scale mixer; (b) obtaining dimensions of a second mixer, wherein the second mixer has a larger fill volume than the selected fill volume; (c) comparing the fill volume of the small-scale mixer to the fill volume of the second mixer to determine a scaling factor; (d) applying the scaling factor to a plurality of dimensions of the second mixer to determine a corresponding plurality of dimensions of the small-scale mixer; (e) using the plurality of dimensions of the small-scale mixer to generate at least one three-dimensional model of the small-scale mixer or components thereof; (f) using the at least one three-dimensional model to produce a small-scale mixer shell, the producing comprising: (i) communicating the at least one three-dimensional model to a first three-dimensional printer to print the small-scale mixer shell; and (ii) subjecting the small-scale mixer shell to smoothing to produce a smoothed small-scale mixer shell; (g) using the at least one three-dimensional model to produce a small-scale mixer impeller having a first quality attribute, the producing comprising: (i) communicating the at least one three-dimensional model to a second three-dimensional printer to print components of the small-scale mixer impeller; (ii) subjecting the components of the small-scale mixer impeller having a second quality attribute to fusion to produce a fused small-scale mixer impeller; and (iii) subjecting the fused small-scale mixer impeller to smoothing to produce a smoothed small-scale mixer impeller; and (h) subjecting the smoothed small-scale mixer shell and the smoothed small-scale mixer impeller to fusion to produce the small-scale mixer.

In one aspect, the printing of the small-scale mixer shell uses a first three-dimensional printer and the printing of components of the small-scale mixer impeller uses a second three-dimensional printer.

In one aspect, the first and second quality attribute includes precision, size, density, surface roughness, and thickness.

In one aspect, the plurality of dimensions of the small-scale mixer and the plurality of dimensions of the second mixer comprise tank width, tank depth, impeller clearance off the bottom of the mixer, liquid level, tank diameter, baffle width, impeller diameter, hub diameter, blade width, blade height, and/or hub height.

In one aspect, the first three-dimensional printer uses a material selected from the group consisting of polycarbonate, acrylonitrile butadiene styrene, polylactic acid, polyethylene terephthalate (PET), nylon, metal, and glass/PET. In a further aspect, the first three-dimensional printer ejects material in liquid or semi-liquid form in order to deposit it in successive layers using a nozzle. In a further aspect, the nozzle has a diameter, or opening in the nozzle, of about 100 μm, about 400 μm, or about 1000 μm, which, in some aspects, results in an extrusion width of about 100 μm, about 400 μm, or about 1000 μm.

In one aspect, the second three-dimensional printer uses a material selected from the group consisting of photosensitive resin, biocompatible resin with minimal leachables and extractables, and low absorption engineering resin. In a specific aspect, the photosensitive resin is dental resin. In another aspect, the second three-dimensional printer comprises an ultraviolet liquid crystal display. In a further aspect, the second three-dimensional printer is configured to print at a resolution in the x and y axis of about 5 μm, about 10 μm, about 20 μm, about 25 μm, about 30 μm, about 45 μm, about 50 μm, about 60 μm, about 70 μm, about 80 μm, about 90 μm or about 100 μm, or any length in between. In a further aspect, the second three-dimensional printer is configured to print at a resolution in the z axis that is about 0.05×, about 0.1×, about 0.2×, about 0.3×, about 0.4×, about 0.5×, about 0.6×, about 0.7×, about 0.8×, about 0.9×, about 1.0×, about 2.0×, about 3.0×, about 4.0×, about 5.0×, about 6.0×, about 7.0×, about 8.0×, about 9.0×, about 10.0×, or about 20.0× the resolution in the x and y axes, or any resolution in between.

In one aspect, the components of the small-scale mixer impeller comprise a bearing clip, pin restraint, top fin section, bottom hub of the impeller, and magnets. In another aspect, the small-scale mixer impeller comprises a magnet configuration.

In one aspect, the smoothing of step (f) (ii) and/or the smoothing of step (g) (iii) comprises coating a surface of the small-scale mixer components with a material selected from the group consisting of photosensitive resin, biocompatible resin with minimal leachables and extractables, and low absorption engineering resin. In a specific aspect, the photosensitive resin is dental resin. In a specific aspect, a number of layers of the material is about 2, about 3, about 4, or about 5. In another specific aspect, the smoothing further comprises curing the surface of the small-scale mixer components coated with the material. In a specific aspect, the curing is performed using a handheld UV light, curing chamber, or a UV photostability chamber.

In one aspect, the smoothing comprises chemically polishing the surface of the small-scale mixer using a volatile solvent.

In one aspect, the smoothing comprises melting a material of the second mixer onto a surface of the small-scale mixer using a heat gun. In another aspect, the material of the second mixer is a linear low density polyethylene.

In one aspect, the smoothing comprises physically polishing a surface of said small-scale mixer using a sand paper, polishing paper, polishing powder, polishing paste, and/or sand blasting.

In one aspect, the fusion of step (g) (ii) and/or the fusion of step (h) comprises use of a material selected from the group consisting of photosensitive resin, biocompatible resin with minimal leachables and extractables, and low absorption engineering resin. In a specific aspect, the photosensitive resin is dental resin. In a specific aspect, the fusion is performed using a handheld UV light, curing chamber, or a UV photostability chamber.

In one aspect, the method further comprises attaching a bearing holder to the bottom of the small-scale mixer impeller prior to step (h).

In one aspect, the small-scale mixer has a fill volume of less than 100 L, less than 50 L, less than 10 L, less than 5 L, less than 3 L, less than 2 L, less than 1 L, between 0.1 and 2 L, or any size in between. In another aspect, the small-scale mixer has a fill volume of about 100 L, about 50 L, about 10 L, about 5 L, about 2 L, about 1.5 L, about 1 L, or about 0.1 L, or any size in between.

In one aspect, the second mixer has a fill volume of greater than 10 L, greater than 50 L, greater than 100 L, greater than 200 L, or greater than 500 L, greater than 1,000 L, greater than 2,000 L, greater than 5,000 L, greater than 10,000, greater than 50,000 L, or any size in between. In another aspect, the fill volume of the second mixer is about 10 L, about 50 L, about 100 L, about 200 L, about 500 L, about 1,000 L, about 2,000 L, about 5,000 L, about 10,000 L, or about 50,000 L, or any size in between.

In one aspect, the scaling factor is from about 0.1 to about 0.5, about 0.1, about 0.2, about 0.3, about 0.4, or about 0.5. In another aspect, the scaling factor is about 0.16.

In one aspect, the method further comprises validating the small-scale mixer by: (a) dividing a sample including a protein into a first sample and a second sample; (b) subjecting the first sample to mixing using the small-scale mixer to produce a first mixed sample; (c) subjecting the second sample to mixing using the second mixer to produce a second mixed sample; and (d) comparing one or more physical parameters of the first mixed sample and the second mixed sample to validate the small-scale mixer, wherein the small-scale mixer and the second mixer are operated at substantially the same mixing parameter. In one aspect, said mixing parameter includes Reynolds, wall shear, vorticity, residence time distribution (RTD), rotations per minute (RPM), and/or tip speed. In a specific aspect, said mixing parameter is tip speed. In a specific aspect, the method further comprises comparing the shear stress of generating the first mixed sample with the shear stress of generating the second mixed sample. In a specific aspect, the one or more physical parameters include one or more of visual inspection, pH, protein concentration, density, turbidity, purity, and particle density. In a specific aspect, the method further comprises obtaining a first mixed sample and a second mixed sample at each of more than one time points.

These, and other, aspects of the disclosure will be better appreciated and understood when considered in conjunction with the following description and accompanying drawings. The following description, while indicating various embodiments and numerous specific details thereof, is given by way of illustration and not of limitation. Many substitutions, modifications, additions, or rearrangements may be made within the scope of the disclosure.

### BRIEF DESCRIPTION OF THE DRAWINGS

FIG. 1 is a block diagram depicting an exemplary method for producing a small-scale mixer, according to aspects of the present disclosure.

FIG. 2 is an illustration depicting exemplary impeller components, according to aspects of the present disclosure.

FIG. 3 is an illustration depicting exemplary impeller components, according to aspects of the present disclosure.

FIG. 4 is an illustration depicting an exemplary impeller, according to aspects of the present disclosure.

FIGS. 5A-5C are illustrations depicting magnet configurations for exemplary impeller assemblies, according to aspects of the present disclosure.

FIG. 6 is an illustration of various exemplary shell components, according to aspects of the present disclosure.

FIG. 7 is an annotated photograph of an exemplary mixer shell used in an exemplary method for producing a small-scale mixer, according to aspects of the present disclosure.

FIGS. 8A and 8B are photographs of an exemplary printer and exemplary small-scale mixer shell, respectively, used in an exemplary method for producing a small-scale mixer, according to aspects of the present disclosure.

FIGS. 9A-9B are illustrations depicting an exemplary small-scale mixer shell, according to aspects of the present disclosure.

FIG. 10 is an annotated photograph of an exemplary mixer impeller assembly used in an exemplary method for producing a small-scale mixer, according to aspects of the present disclosure.

FIGS. 11A and 11B are photographs of an exemplary printer and exemplary impeller, respectively, used in an exemplary method for producing a small-scale mixer, according to aspects of the present disclosure.

FIG. 12A is an illustration depicting exemplary small-scale mixer impeller components, according to aspects of the present disclosure. FIGS. 12B-12C are illustrations depicting exemplary small-scale mixer impeller assemblies, according to aspects of the present disclosure.

FIG. 13 is an illustration of an exemplary small-scale mixer, according to aspects of the present disclosure.

### DETAILED DESCRIPTION

During manufacturing and formulation of a pharmaceutical product, mixing components is a necessary step. For example, excipients may be added to a drug substance in order to obtain a formulated drug product, which requires mixing any added excipients or solutions using a mixing device. However, mixing can introduce shear stresses that can adversely affect components of a formulation, in addition to presenting risks of adsorption and aggregation. These risks are particularly noteworthy when formulating biopharmaceutical products, which can include large molecules, such as proteins, with specific three-dimensional structures that are vulnerable to unfolding, aggregation, or degradation. Improperly folded, aggregated or degraded biopharmaceutical products may reduce the efficacy of the drug product and increase risks of an undesirable immune response.

Therefore, characterization of shear stresses introduced by mixing processes, and characterization of the vulnerability of formulation components to shear stresses, may be useful to minimize risks such as degradation during process development. However, typical studies to determine the effects of shear stress on the stability of pharmaceutical products are often not economical. Large volumes of material, for example, a minimal fill volume of 10-20 L, are required, and the materials needed for pharmaceutical products are expensive to procure. Furthermore, the timeline for completing these studies is generally very short.

One approach for addressing the challenges associated with implementing shear stress studies is through the production of a small-scale mixer. The use of a small-scale mixer can minimize material usage and reduce the time and costs associated with batch manufacture. Systems and methods for producing a small-scale mixer using a three-dimensional (3D) printer have been previously disclosed. See U.S. patent application Ser. No. 17/395,176 filed on Aug. 5, 2021, published as U.S. Publication No. 2022/0040926A1 on Feb. 10, 2022, the entire contents of which are hereby incorporated by reference in its entirety.

The disclosure herein provides a solution to producing a small-scale mixer such that the dimensions of the small-scale mixer are based on the dimensions of a respective at-scale mixer. In some exemplary embodiments, each of the dimensions of a small-scale mixer are related to the dimensions of a respective at-scale mixer by the same scaling factor. By implementing new techniques in 3D printing and magnet customization, it is demonstrated that a scaled-down impeller can be produced. In some exemplary embodiments, the scaled-down impeller can be printed using a high-resolution resin 3D printer. In other exemplary embodiments, the magnet for the impeller can be customized depending on the mixer motor. The magnet can be magnetized either axially with four alternating poles (e.g., going clockwise around, one magnet has a pole going down, the next up, and the last one down) from four separate 90-degree arc magnets, or diametrically. Axial magnetization allows for use of maglev drivers and diametrically allows for use of magnetic stir plates.

By producing a small-scale mixer such that all components of the mixer are scaled down from a large-scale mixer, the mixing conditions of the at-scale mixer can be replicated at small scale. Thus, faster and cost-effective testing methodologies can be implemented to characterize pharmaceutical products.

### Definitions

Unless described otherwise, all technical and scientific terms used herein have the same meaning as commonly understood by one of ordinary skill in the art to which this disclosure belongs. Although any methods and materials similar or equivalent to those described herein can be used in the practice or testing, particular methods and materials are now described.

The term “a” should be understood to mean “at least one” and the terms “about” and “approximately” should be understood to permit standard variation as would be understood by those of ordinary skill in the art, and where ranges are provided, endpoints are included. As used herein, the terms “include,” “includes,” and “including” are meant to be non-limiting and are understood to mean “comprise,” “comprises,” and “comprising” respectively.

As used herein, the term “protein” includes any amino acid polymer having covalently linked amide bonds. Proteins comprise one or more amino acid polymer chains, generally known in the art as “polypeptides.” “Polypeptides” refers to polymers composed of amino acid residues, related naturally occurring structural variants, and synthetic non-naturally occurring analogs thereof linked via peptide bonds related naturally occurring structural variants, and synthetic non-naturally occurring analogs thereof. “Synthetic peptides or polypeptides” refers to non-naturally occurring peptides or polypeptides. Synthetic peptides or polypeptides can be synthesized, for example, using an automated polypeptide synthesizer. Various solid phase peptide synthesis methods are known to those of skill in the art. A protein may contain one or multiple polypeptides to form a single functioning biomolecule. A protein can include any of bio-therapeutic proteins, recombinant proteins used in research or therapy, trap proteins and other chimeric receptor Fc-fusion binding molecules, chimeric proteins, antibodies, monoclonal antibodies, polyclonal antibodies, human antibodies, and bispecific antibodies. In another exemplary aspect, a protein can include antibody fragments, nanobodies, recombinant antibody chimeras, cytokines, chemokines, peptide hormones, and the like. Proteins may be produced using recombinant cell-based production systems, such as the insect bacculovirus system, yeast systems (e.g., Pichia sp.), and mammalian systems (e.g., CHO cells and CHO derivatives like CHO-K1 cells). For a review discussing biotherapeutic proteins and their production, see Darius Ghaderi et al., “Production platforms for biotherapeutic glycoproteins. Occurrence, impact, and challenges of non-human sialylation”, Biotechnology and Genetic Engineering Reviews, 2012, Volume 28, Issue 1, Pages 147-176. In some exemplary embodiments, proteins comprise modifications, adducts, and other covalently linked moieties. Those modifications, adducts and moieties include for example avidin, streptavidin, biotin, glycans (e.g., N-acetylgalactosamine, galactose, neuraminic acid, N-acetylglucosamine, fucose, mannose, and other monosaccharides), PEG, polyhistidine, FLAG tag, maltose binding protein (MBP), chitin binding protein (CBP), glutathione-S-transferase (GST) myc-epitope, fluorescent labels and other dyes, and the like. Proteins can be classified on the basis of compositions and solubility and can thus include simple proteins, such as, globular proteins and fibrous proteins; conjugated proteins, such as, nucleoproteins, glycoproteins, mucoproteins, chromoproteins, phosphoproteins, metalloproteins, and lipoproteins; and derived proteins, such as, primary derived proteins and secondary derived proteins.

As used herein, the term “formulation” refers to a pharmaceutical product that is formulated together with one or more pharmaceutically acceptable vehicles. In certain exemplary embodiments, the pharmaceutical product can comprise a shear sensitivity molecule, such as a formulated drug substance (“FDS”). In certain exemplary embodiments, the pharmaceutical product can also include a surfactant.

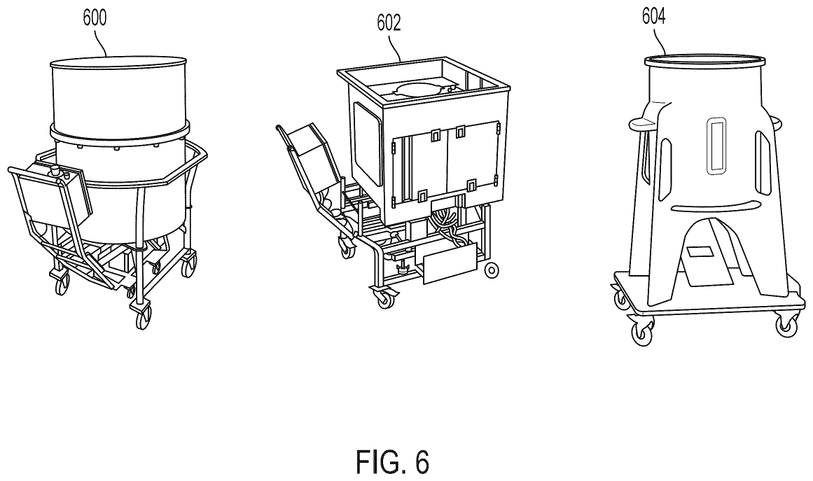

As used herein, the term “mixer” refers to any type of mixing apparatus. In some exemplary embodiments, the mixer may be configured for pharmaceutical product manufacturing. For example, the mixer can mix pharmaceutical ingredients from intermediate to final drug products, and/or can be configured for the preparation of process solutions, such as buffers and media. In exemplary embodiments, the mixer can comprise a tank or shell, an impeller, a single-use mixing bag (e.g., “bio-container”), and a separate interchangeable drive unit. The mixer, for example, can be commercially available and marketed as, for example, LevMixer® Single-Use Mixing Systems by Pall Life Sciences of Port Washington NY, USA, Flexsafe® Single-Use Mixing Systems by Sartorius of Gottingen, Germany, or Mobius® Single-Use Mixing Systems by Merck KGaA of Darmstadt, Germany, shown in FIG. 6.

As used herein, the term “tank” or “shell” refers to a container that holds the various ingredients together.

As used herein, the term “impeller” refers to a rotating component of a mixer that propels and mixes the ingredients in a tank.

As used herein, the term “shear stress” refers to forces which are exerted on particles dispersed in solution, such as, for example, biopharmaceutical products. In some exemplary embodiments, the forces imparted to a pharmaceutical product can be a result of encountering an impeller.

As used herein, the term “three-dimensional (3D) printer” refers to a machine that produces a three-dimensional solid object from a three-dimensional digital model. In some exemplary embodiments, the 3D printer creates the three-dimensional object by laying down thin layers of a material in succession.

As used herein, the term “magnet” refers to material that can produce its own magnetic field. In some exemplary embodiments, magnets can be located in an impeller and a drive unit of the mixer. Once the mixer is powered on, the magnets on the drive unit can generate a magnetic field which drives the rotation of the magnetic impeller. In some exemplary embodiments, an electromagnet is used for the drive unit.

As used herein, the term “resolution” refers to the accuracy, or level of detail, allowed by a 3D printer. Resolution can be determined by the smallest movement a 3D printer can make in a certain direction. In some exemplary embodiments, resolution can be defined by an extrusion width, the smallest distance that a 3D printer can move in the horizontal direction, or the x and y axes. In other exemplary embodiments, resolution can be defined by the smallest distance that a 3D printer can move in the vertical direction, or the z axis.

As used herein, the term “fusion deposition modeling” refers to a 3D printing process in which layers of melted material are selectively deposited in a predetermined path. In some exemplary embodiments, fusion deposition modeling is also known as fused filament fabrication.

As used herein, the term “resin” refers to a solid or highly viscous substance of plant or synthetic origin that can be polymerized. In some exemplary embodiments, the resin is photosensitive and the resin can change properties when exposed to light. In some exemplary embodiments, the resin can include dental resin, biocompatible resins with minimal leachables and extractables, low absorption engineering resins, or other photosensitive polymers.

As used herein, the term “liquid crystal display (LCD) screen” refers to a screen which uses liquid crystals to selectively mask a light source so that only selected areas are printed in a layer. In some exemplary embodiments, the light source uses an array of ultraviolet light-emitting diodes. In a 3D printer, the light from the LCD screen can shine directly in a parallel fashion to cure the resin. The term “cure” herein refers a chemical process in which a polymer material is toughened or hardened as a result of cross-linking of polymer chains. Curing of the polymer material may be induced by heat, radiation, electron beams, or chemical additives. In some exemplary aspects, curing is induced by UV light.

As used herein, the term “smoothing apparatus” refers to a machine that can process a rough object to remove the imperfections and smooth the surface.

As used herein, the term “fusing apparatus” refers to a machine that can fuse two components together.

### Methods and Systems for Producing Small-Scale Mixers

Provided herein are methods for producing a small-scale mixer based on dimensions of an at-scale mixer. Further provided herein are systems for producing a small-scale mixer, and the systems may include an at-scale mixer, a small-scale mixer, at least one 3D-printer, at least one smoothing apparatus, and a fusing apparatus.

A method of the present disclosure may first include selecting a fill volume for a small-scale mixer. In some exemplary embodiments, the small-scale mixer can have a fill volume less than or equal to about 2 liters. In some exemplary embodiments, the small-scale mixer can have a fill volume between about 0.05 liters and about 2 liters. For example, the small-scale mixer can have a fill volume of about 1 liter. It is understood that an actual capacity of the small-scale mixer may exceed its targeted capacity (e.g., by about 40%).

A method of the present disclosure further includes obtaining dimensions of an at-scale mixer. In some exemplary embodiments, the at-scale mixer can have a fill-volume greater than or equal to about 10 liters. In some exemplary embodiments, the at-scale mixer can have a fill volume between about 10 liters and about 50,000 liters. It is understood that an actual capacity of a mixer may exceed its indicated capacity. For example, the actual capacity of a mixer (e.g., 140 liters) may exceed its indicated capacity (e.g., 100 liters) by about 40%.

In some exemplary embodiments, the dimensions of the at-scale shell can include the following: tank width (TW₁), tank depth (TD₁), impeller clearance off bottom of mixer (C₂), liquid level (H₂), tank diameter (T₂), and baffle width (WB₂). The dimensions of the at-scale impeller can include the following: impeller diameter (D₂), hub diameter (HD₂), blade width (BW₂), blade height (BH₂), and hub height (HH₂). The dimensions can be determined from reference documentation, manually measured, or automatically measured (by, e.g., optical scanning).

The small-scale mixer can have dimensions proportional to the dimensions of the at-scale mixer. In some exemplary embodiments, the dimensions of the small-scale mixer can include the following: tank width (TW₂), tank depth (TD₂), impeller clearance off bottom of mixer (C₁), liquid level (H₁), tank diameter (T₁), baffle width (WB₁), impeller diameter (D₁), hub diameter (HD₁), blade width (BW₁), blade height (BH₁), and hub height (HH₁).

In some exemplary embodiments, the small-scale mixer can have dimensions that are related to the dimensions of the at-scale mixer by an equal or substantially equal scaling factor. The method of the present disclosure can includes selecting a scaling factor for the small-scale mixer. In some exemplary embodiments, the scaling factor can be selected to obtain a target fill volume of the small-scale mixer. For example, the scaling factor can be selected to provide a fill volume of 1 liter. Additionally, the scaling factor can be a ratio between: TW₁/TW₂, TD₁/TD₂, C₁/C₂, H₁/H₂, T₁/T₂, WB₁/WB₂, D₁/D₂, HD₁/HD₂, BW₁/BW₂, BH₁/BH₂, and HH₁/HH₂, wherein the ratios have equal values or substantially equal values. In some exemplary embodiments, the scaling factor is about 0.1623. In some exemplary embodiments, the scaling factor is from about 0.1 to about 0.5, about 0.1 to about 0.2, about 0.1, about 0.15, about 0.16, about 0.17, about 0.18, about 0.19, about 0.2, about 0.25, about 0.3, about 0.35, about 0.4, about 0.45, or about 0.5.

Using the desired dimensions of a small-scale mixer determined by a scaling factor, a small-scale mixer can be produced by 3D printing. In some exemplary embodiments, the shell and impeller of a small-scale mixer are generated separately. In some exemplary embodiments, the shell can be printed using a first 3D printer that has a comparatively lower resolution, higher build volume, higher material volume, lower build cost, and/or requires less maintenance. In some exemplary embodiments, the impeller can be printed using a second 3D printer that has a comparatively higher resolution (for example a very high resolution of about 25 μm), smaller build volume, small or medium material volume, higher build cost, and/or may require additional maintenance. This dual printing system allows for dual benefits: high-throughput benefits for printing of a shell where high resolution details are less important, and high precision benefits for printing of an impeller where accuracy up to a higher resolution is very important. The shell and impeller components can be modeled using computational software before printing.

The lower resolution printer can be a conventional 3D printing system, which can use fusion deposition modeling (FDM), stereolithography, selective laser sintering, selective laser melting, electronic beam melting, or other suitable 3D printing techniques. In some exemplary embodiments, the 3D printer can print 3D structures using PC (Polycarbonate), ABS (acrylonitrile butadiene styrene), PLA (polylactic acid), PET (polyethylene terephthalate), nylon, metal, glass/PET, or other suitable materials. In other exemplary embodiments, the 3D printer can comprise a nozzle, which ejects material in liquid or semi-liquid form in order to deposit it in successive layers within the 3D printing volume. In some exemplary embodiments, the nozzle can have a diameter, or opening in the nozzle, of about 50 μm, about 100 μm, about 400 μm, or about 1000 μm, which can result in an extrusion width of about 50 μm, about 100 μm, about 400 μm, or about 1000 μm.

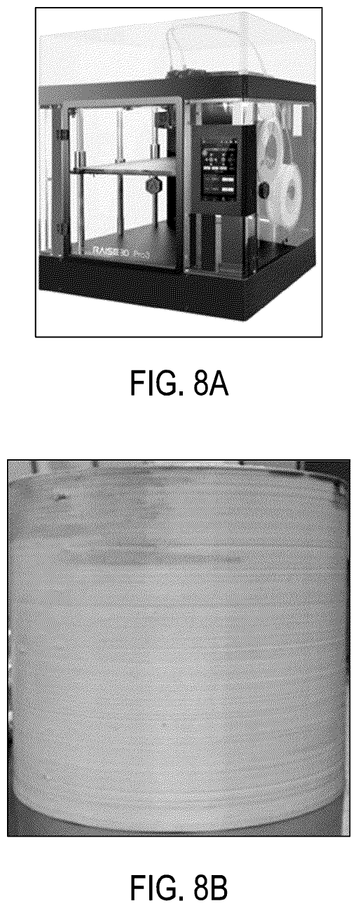

A printer for producing the shell can include a fusion deposition modeling (FDM) 3D printer. For example, the FDM 3D printer may be as shown in FIG. 8A. In some exemplary embodiments, the FDM printer can be a Raise3D Pro2 3D printer. The FDM printer utilizes high temperatures to melt plastics and extrude builds. As noted above, the materials for 3D printing can include PC (Polycarbonate), ABS (acrylonitrile butadiene styrene), PLA (polylactic acid), PET (polyethylene terephthalate), nylon, metal, glass/PET, or other suitable materials. The printer has a low build cost and can produce high build volume but will require high material volume and provide less resolution. Thus, the FDM printer can be used for creating mixer shells and other large components where high resolution is less important.

The higher resolution printer can be a resin 3D printer, which can utilize a liquid crystal display (LCD) screen, a digital light processing (DLP) screen, or stereo lithography apparatus (SLA). In some exemplary embodiments, the resin printer can print 3D structures using dental resin, biocompatible resins with minimal leachables and extractables, low absorption engineering resins, or other photosensitive polymers. In some exemplary embodiment, the resin 3D printer can be configured to print at a constant resolution in the x and y axes of about 5 μm, about 10 μm, about 20 μm, about 30 μm, about 45 μm, about 50 μm, about 60 μm, about 70 μm, about 80 μm, about 90 μm, about 100 μm, or any length in between. In other exemplary embodiments, the resin 3D printer can be configured to print at a resolution in the z axis that is about 0.05×, about 0.1×, about 0.2×, about 0.3×, about 0.4×, about 0.5×, about 0.6×, about 0.7×, about 0.8×, about 0.9×, or about 1.0× the resolution in the x and y axes, or any resolution in between.

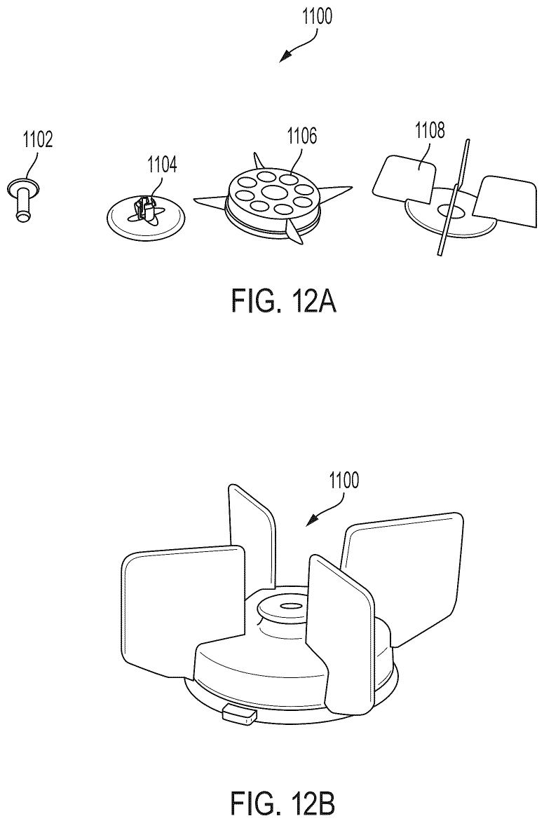

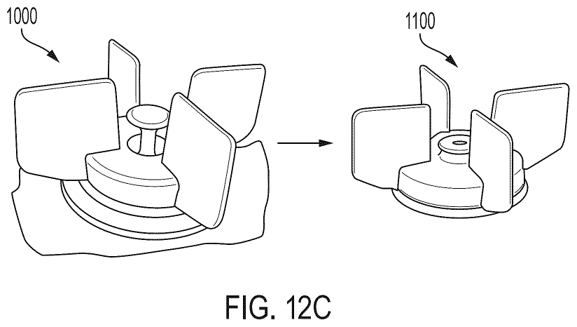

A printer for producing the impeller can include a liquid crystal display (LCD) resin printer. For example, the LCD resin printer may be as shown in FIG. 12A. In some exemplary embodiments, the LCD resin printer can include a Phrozen Sonic Mighty 8K resin 3D printer. The LCD resin printer utilizes liquid photosensitive polymers as its build material and an ultraviolet (UV) LCD screen as its light source to solidify the liquid polymer. As noted above, the photosensitive polymer can include dental resin, or other suitable materials. In contrast to the FDM printer, the LCD resin printer has a higher build cost and smaller build volume. However, the LCD resin printer requires medium material volume and provides very high resolution. In some exemplary embodiments, the resolution can be as high as 25 μm. Thus, the LCD resin printer can be used for creating the impeller with high accuracy.

In some exemplary embodiments, the impeller components are printed separately using the resin 3D printer. The impeller components can include a bearing clip, a pin restraint, top fin section, bottom hub of the impeller, and magnets. For example, FIG. 12B shows a fused impeller with a top fin section, bottom hub, pin restraint, and four axially magnetized magnets for maglev configurations.

After printing of the impeller components, the impeller can be assembled using resin with custom magnets and magnet configurations inserted onto the bottom hub of the impeller. In some embodiments, the magnets may be inserted into the bottom of the impeller. The impeller can be modified to accept different kinds of magnets depending on the desired mixer motor. The use of custom magnets allows for the effective scale down of all mixer components, including the impeller, thereby providing greater control over shear stress. In some embodiments, the magnet configuration may comprise alternating or vertical poles for magnetic levitation (maglev) motors. In some embodiments, the magnet configuration may comprise a unified or horizontal pole for magnetic stir plate motors. In some embodiments, the magnet configuration may be optimized to contain more accurate and stronger fields.

Surfaces of objects generated by a 3D printer can be rough due to imperfections, such as burrs, rough edges, and the like. The imperfections can result from the 3D printing process and can degrade pharmaceutical products during mixing, for example, by causing friction, particle generation, and shear forces. The systems and methods of the present disclosure can include a smoothing apparatus after printing of the objects generated by a 3D printer.

In some exemplary embodiments, the smoothing apparatus comprises a handheld ultraviolet (UV) light, curing chamber, or a UV photostability chamber. In some exemplary embodiments, the smoothing process includes applying at least one layer of resin onto the surface of the object. Additional layers, or coats, of resin may be used to smooth out larger imperfections. The resin material can include dental resin, biocompatible resins with minimal leachables and extractables, low absorption engineering resins, or other photosensitive polymers. Resins with minimal water absorbance may be of particular interest. Following the application of at least one layer of resin, a handheld UV light, curing chamber, or a UV photostability chamber can be used to cure the at least one layer of resin.

In some exemplary embodiments, the smoothing apparatus comprises a solvent bath that polishes the 3D shapes formed from materials used by the 3D printer. For example, the solvent bath can use acetone, dichloromethane, or other solvents to smooth, for example, ABS or polycarbonate. In some exemplary embodiments, the small-scale mixer generated by the 3D printer is polished using vapor produced by the solvent. In some embodiments, the small-scale mixer is polished by dipping it directly into a pool of solvent. In other exemplary embodiments, a heat gun can be used to melt the material from the at-scale mixer onto the surface of the small-scale mixer in order to smooth its surface. The small-scale mixer's ability to replicate the properties of protein adsorption may be enhanced by use of the at-scale mixer material. In some exemplary embodiments, the material of the at-scale mixer can include linear low density polyethylene. In other exemplary embodiments, the smoothing apparatus comprises physical abrasion. In other exemplary embodiments, the smoothing apparatus can be sand paper, polishing paper, polishing powder, polishing past, and/or sand blasting.

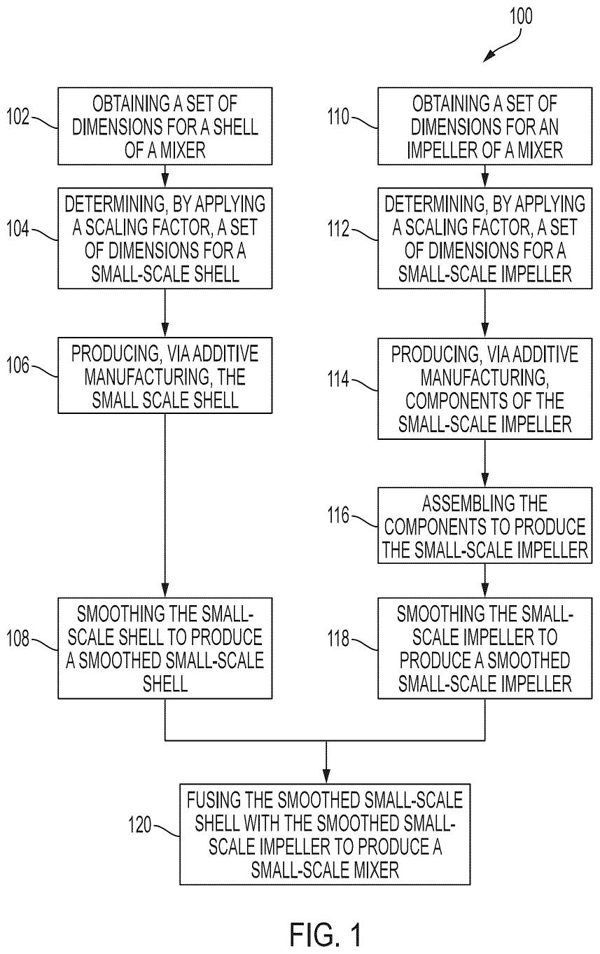

Referring now to FIG. 1, disclosed herein is an exemplary method 100 for producing a small-scale mixer having a small-scale shell and a small-scale impeller assembly based on a mixer having a shell and an impeller assembly. In some embodiments, steps may be performed in parallel, such that steps 102-108 may be performed in parallel with steps 110-118. In some embodiments, steps may be performed sequentially, such that steps 102-108 may be performed before steps 110-118. At step 102, a first set of dimensions for the shell of the mixer may be obtained. At step 104, a second set of dimensions for a small-scale shell may be determined by applying a scaling factor. At step 106, the small-scale shell may be produced via additive manufacturing based on the second set of dimensions. At step 108, the small-scale shell may be smoothed to produce a smooth small-scale shell. At step 110, a third set of dimensions for the impeller assembly of the mixer may be obtained. At step 112, a fourth set of dimensions for a small-scale impeller assembly may be determined by applying a scaling factor. At step 114, one or more small-scale components of the small-scale impeller assembly may be produced via additive manufacturing based on the fourth set of dimensions. At step 116, the one or more small-scale components may be assembled to produce the small-scale impeller assembly. At step 118, the small-scale impeller assembly may be smoothed to produce a smooth small-scale impeller assembly. At step 120, the smooth small-scale shell and smooth small-scale assembly are fused to produce the small-scale mixer.

The one or more small-scale components of the small-scale impeller assembly may be based on one or more components of the impeller assembly of the mixer. The one or more components of the impeller assembly of the mixer may comprise an impeller. In some embodiments, the one or more components of the impeller assembly of the mixer may comprise additional components, such as support components. In some embodiments, the one or more components may comprise a pin restraint to secure the impeller in place. In some embodiments, the one or more components may comprise a bearing support is attached to the impeller by placing bearings inside a bearing holder and clipping the bearing holder to the bottom of the impeller. In some embodiments, the impeller assembly of the mixer may consist of an impeller.

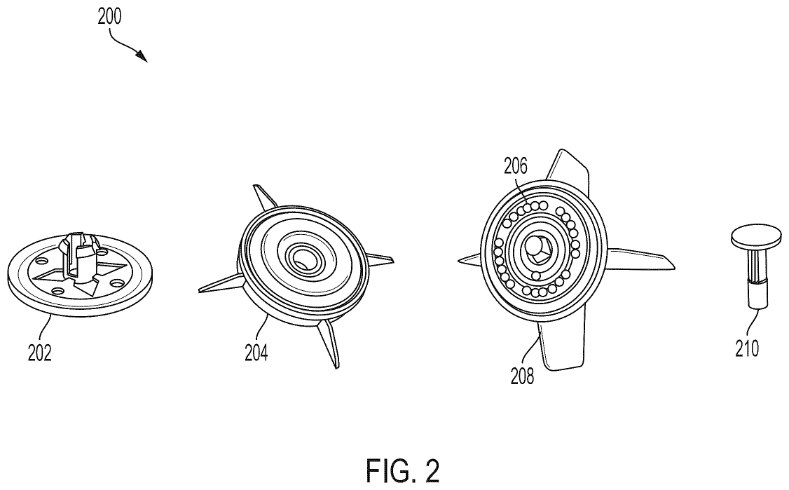

FIG. 2 illustrates components of an exemplary impeller 200, which may be scaled down to produce components of a small-scale impeller. The impeller 200 may comprise a bottom hub 202, a bearing holder 204, ball bearings 206, a top fin section 208, and a pin restraint 210.

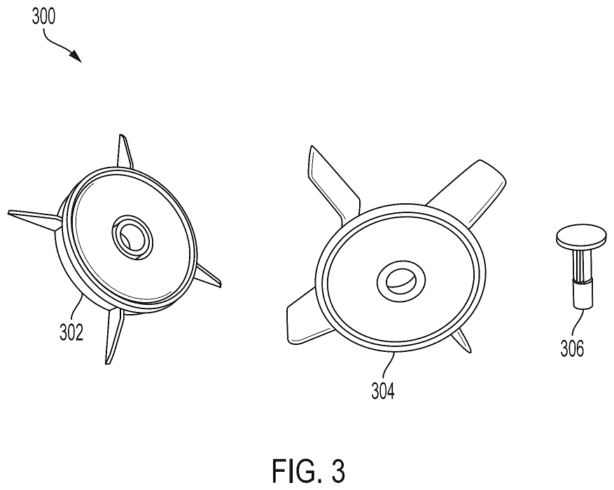

FIG. 3 illustrates components of another exemplary impeller 300, which may be scaled down to produce components of a small-scale impeller. The impeller 300 may comprise a bottom support component 302, a top fin section 304, and a pin restraint 306.

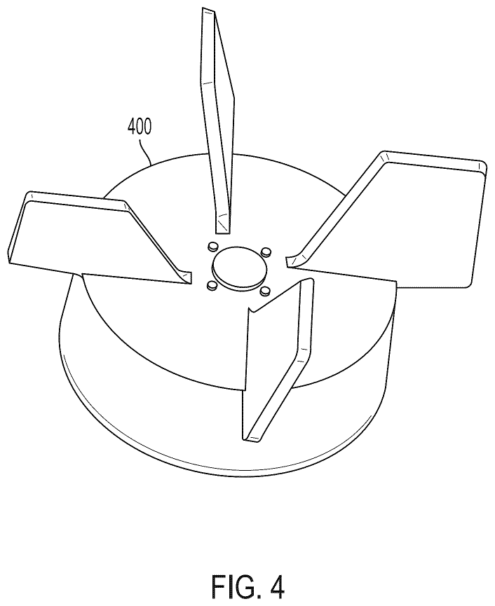

FIG. 4 illustrates another exemplary impeller 400, which may be scaled down to produce a small-scale impeller.

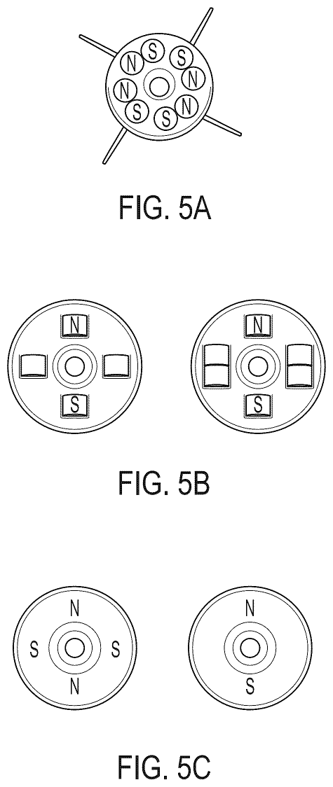

In some embodiments, the small-scale impeller assembly may comprise a magnet configuration as described herein. The magnets may be inserted into the bottom of the impeller. The impeller may be modified to accept different kinds of magnets depending on the desired mixer motor. The use of custom magnets allows for the effective scale down of all mixer components, including the impeller, thereby providing greater control over shear stress. As shown in FIG. 5A, the magnet configuration may comprise alternating or vertical poles for magnetic levitation (maglev) motors. As shown in FIG. 5B, the magnet configuration may comprise a unified or horizontal pole for magnetic stir plate motors. As shown in FIG. 5C, the magnet configuration may comprise additional configurations that contain more accurate and stronger fields than the corresponding configurations of FIGS. 5A and 5B, respectively.

The small-scale shell of the small-scale mixer may be based on a shell of a mixer. FIG. 6 illustrates exemplary shell components of mixers which may be scaled down to produce a small-scale shell. As shown in FIG. 6, in some embodiments, an exemplary shell 600 may be configured to fuse and operate with an impeller assembly comprising an impeller, a pin restraint, bearings, and a bearing holder. In some embodiments, an exemplary shell 602 may be configured to fuse and operate with an impeller assembly comprising an impeller and a pin restraint. In some embodiments, an exemplary shell 604 may be configured to fuse and operate with an impeller assembly consisting of an impeller.

Once the smooth small-scale shell and small-scale impeller assembly are produced, the small-scale mixer can be assembled by fusing the small-scale shell and small-scale impeller assembly together using a fusing apparatus. In some embodiments, resin can be applied to a bottom surface of the small-scale impeller assembly to secure the small-scale impeller assembly to the small-scale shell, and the assembled small-scale mixer can then be placed under a fusing apparatus, wherein the resin that is used to secure the small-scale shell and small-scale impeller assembly together is cured.

In some embodiments, the fusing apparatus comprises a handheld UV light, curing chamber, or a UV photostability chamber. In some embodiments, the fusing apparatus can be the same apparatus as the smoothing apparatus. In some embodiments, the fusing process includes applying at least one layer of resin onto a surface joining the small-scale shell and small-scale impeller assembly together, and curing the resin. Additional layers, or coats, of resin may be used to smooth out larger imperfections. The resin material can include dental resin, biocompatible resins with minimal leachables and extractables, low-absorption engineering resins, or other photosensitive polymers. Resins with minimal water absorbance may be of particular interest. Following application of at least one layer of resin, a handheld UV light, a curing chamber, or a UV photostability chamber can be used to cure the at least one layer of resin.

In some embodiments, the methods described herein further comprise validating mixing of a product by comparing the small-scale mixer to the corresponding (at-scale) mixer. In some embodiments, the product can be a bulk drug substance, which may be highly sensitive to shear. Prior to a mixing study, the bulk drug substance may be diluted to the final formulated drug substance (FDS). The validation process can include evaluating the stability of a product, such as, for example, a bulk drug substance, when exposed to shear forces. The validation can include mixing the product for a period of time (e.g., 24 hours) with the at-scale mixer and the small-scale mixer in parallel at a constant tip speed, periodically sampling the product from the (at-scale) mixer and the small-scale mixer, and determining whether a quality of the product has substantial differences in any of pH, protein concentration, surfactant, density, turbidity, purity and particle density based on comparisons of the respective samples.

In some embodiments, the methods described herein may further comprise evaluating effects of shear stress from mixing of a product using the small-scale mixer. In some embodiments, the effects of shear stress from mixing products can be determined. For example, the determination of shear stress effects can be based on constant impeller tip speed and/or power-to-volume ratio (P/V). The term “impeller tip speed” refers to the velocity of the outer edge of the impeller. As the highest mixing shear stress occurs at the impeller tip, maintaining a constant tip speed avoids damage to products, such as, pharmaceutical products. The term “power-to-volume ratio (P/V)” refers to the effective energy input by unit volume of fluid. P/V (W/m³ (SI unit)) can be determined using the following equation, wherein No is a power number, p is density of the fluid (kg/m³), N is the impeller speed (rpm or s⁻¹) and D is the diameter of the impeller (m):

$$\frac{P}{V} = \frac{{N}_{ρ} ρ {N}^{3} {D}^{5}}{V}$$

The systems and methods disclosed herein will be more fully understood by reference to the following Examples. They should not, however, be construed as limiting the scope of the disclosure.

### EXAMPLES

### Example 1: Production of a Small-Scale Mixer

This example demonstrates the successful production of a small-scale mixer produced using an exemplary method of the present disclosure.

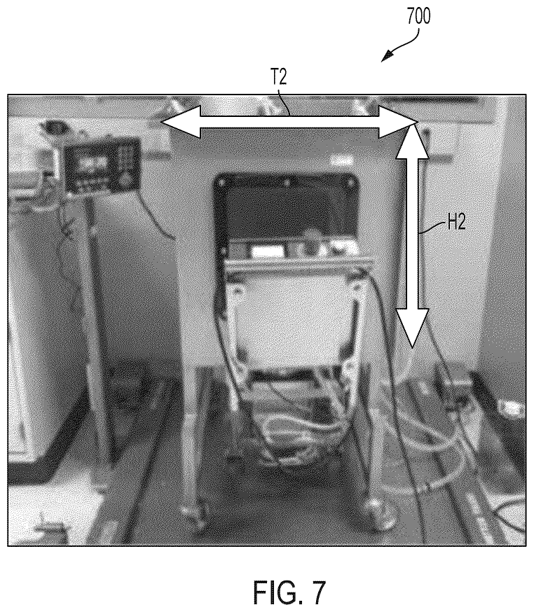

A mixer 700 was measured to determine dimensions of the shell, including height (H2) and width (T2), as annotated in FIG. 7. Each dimension (H2, T2) was multiplied by a scaling factor of 0.1623 (e.g., 16.23%) to obtain corresponding dimensions for a small-scale shell. A 3D model of the small-scale shell was made using Solidworks 2019 3D computer-aided design software and exported as a Standard Triangle Language (STL) file. The shells were then sliced using IdeaMaker 3D computer-aided slicing software with the following parameters: layer height of 0.35 mm, extrusion width of 0.45 mm, bed temperature of 65° C., extruder temperature of 207° C., print speed of 80 mm/s, print acceleration of 600 mm/s, print jerk of 5 mm/s², two bottom and top solid fill layers, 20% grid infill density, maximum fan speed, 15 second minimum layer time, retraction material amount of 1.6 mm and retraction speed of 60 mm/s.

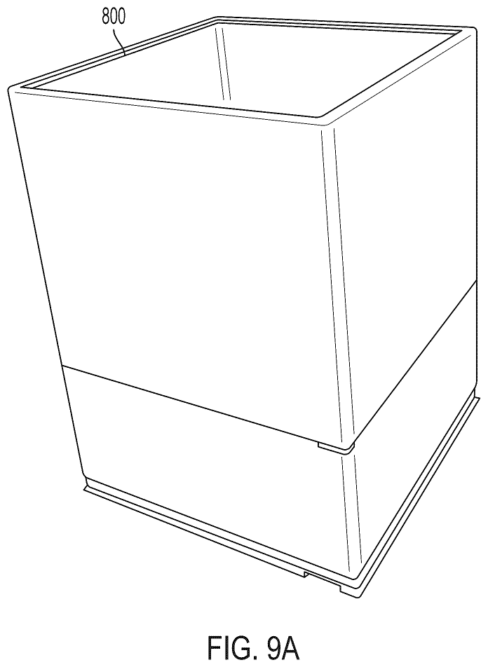

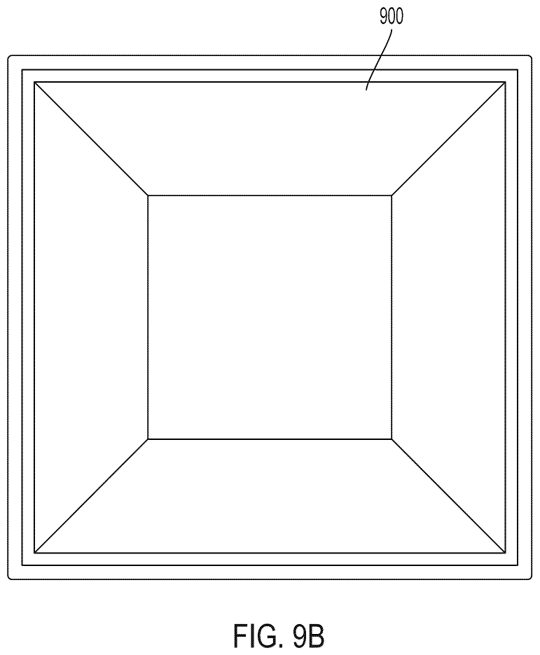

A low-resolution fused deposition modeling 3D printer (FIG. 8A) was used to print a small-scale shell from polylactic acid (PLA) material (FIG. 8B, FIG. 9A), based on the 3D model. As shown in FIG. 9B, the small-scale shell 800 comprised an interior surface 900.

Next, a liquid photosensitive dental resin was applied a layer onto the interior surface of the small-scale shell and then cured using an ultravisible (UV) light chamber to produce a smooth small-scale shell based on the shell of the mixer. Smoothing the small-scale mixer shell can include use of a handheld UV light, a curing chamber, or UV photostability chamber to cure resin layers that are coated onto the surfaces. Curing with UV light is a solventless process, as cure occurs via direct polymerization rather than evaporation. The walls and bottom of the interior surface of the shell were coated with a layer of liquid dental resin. The container was inverted and excess resin was allowed to flow out until a uniform layer remained. The resin was then cured using UV light from a curing chamber for 30 minutes. The use of resin on the surfaces of the shell results in a smooth finish. Multiple coats of resin may be necessary for robust coating or to smooth out larger imperfections. In this example, 3-5 coats were added and cured to give the inside of the mixer shell a sufficiently smooth surface.

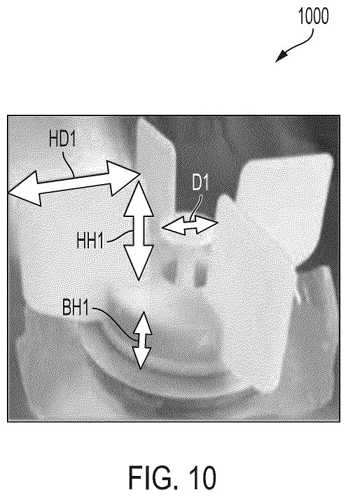

The mixer was further measured to determine dimensions of the impeller assembly, including diameter (D1), blade width (HD1), base height (BH1), and blade height (HH1), as annotated in FIG. 10. Each dimension of the impeller assembly was multiplied by a scaling factor, 0.1623 (or 16.23%), to obtain the corresponding dimensions for a small-scale impeller assembly.

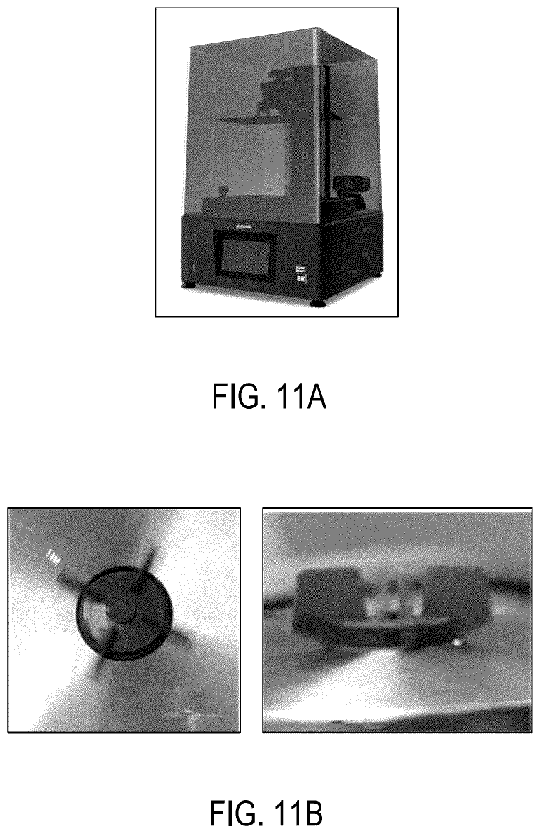

A high-resolution LCD resin 3D printer (FIG. 11A) was used to print the small-scale impeller (FIG. 11B) from dental resin. As shown in FIG. 12A, components of the impeller 1100 were printed separately. The small-scale components—which included a pin restraint 1102, bottom hub 1104, magnets 1106, and top fin section 1108—were modeled using SolidWorks 2019 3D computer-aided design software and exported as an STL file. The small-scale components were sliced using ChituBox 3D computer-aided slicing software and printed on a Phrozen Mighty 8K Resin 3D Printer using dental resin with a layer height of 0.05 mm, a bottom layer count of 6, an exposure time of 5.2 seconds, a bottom exposure time of 15 seconds, a transition layer count of 6, a 8 mm lift and retract distance, a 60 mm/minute lift speed and 150 mm/minute retract speed, and a 2 second rest between lifting and retracting. The small-scale components were then washed in 99% isopropyl alcohol and then removed from their supports.

As shown in FIG. 12B, the small-scale components were then assembled to form the small-scale impeller assembly, using resin along with custom magnets and magnet configurations. During assembly, magnets were inserted into the bottom hub of the impeller can have magnets inserted. Once the impeller components were assembled together, resin was spread onto the cracks between the impeller components to hold the components together. The resin was cured using a UV chamber, which resulted in a smooth, uniform surface between components. Imperfections generated by the addition of liquid resin were carefully removed with a razor blade to produce a flat surface on the impeller blades.

Next, a liquid photosensitive dental resin was applied a layer onto the surface of the small-scale impeller assembly and then cured using a UV light chamber to produce a smooth small-scale impeller assembly based on the impeller assembly of the (at-scale) mixer. FIG. 12C shows side view images of the impeller assembly of the (at-scale) mixer and the impeller assembly of the small-scale mixer after the dimension scale-down procedure. As described above, the dimensions of the small-scale impeller assembly were proportional to the at-scale impeller assembly, based on a common scaling factor. In this example, the scaling factor used in the scale-down procedure had a value of 0.1623.

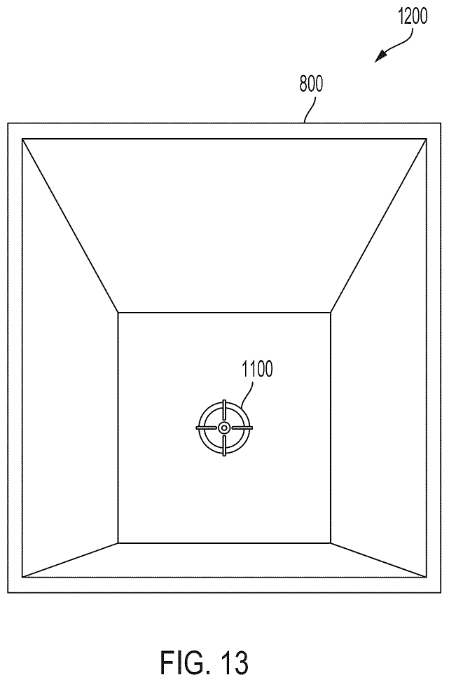

The smooth small-scale impeller assembly 1100 was then inserted into the smooth small-scale shell 800, as shown in FIG. 13. A small amount of liquid resin was applied to the bottom of the pin restraint of the impeller assembly in order to secure the impeller in place. The assembled small-scale mixer 1200 was then cured over a day in a photostability chamber using UV.

The present disclosure is not to be limited in terms to the particular examples described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The following items are exemplary embodiments of the systems and methods disclosed herein, and are not intended to be limiting.

Item 1. A system for producing a small-scale mixer that replicates mixing operations of a second mixer, comprising:
(a) at least one three-dimensional printer operable to produce a first and second set of predetermined components with a respective first and second quality attribute of said small-scale mixer that replicate operation of corresponding components of said second mixer;
(b) at least one smoothing apparatus configured to smooth a surface of said components of said small-scale mixer produced by said at least one three-dimensional printer; and
(c) a fusing apparatus configured to fuse the smoothed components of said small-scale mixer to produce said small-scale mixer.

Item 2. The system of item 1, wherein said at least one three-dimensional printer comprises a first three-dimensional printer and a second three-dimensional printer.

Item 3. The system of item 1, wherein said respective first and second quality attribute of said small-scale mixer includes precision, size, density, surface roughness, and thickness.

Item 4. The system of item 1, wherein said small-scale mixer has a fill volume of less than 50 L, less than 10 L, less than 5 L, less than 3 L, less than 2 L, less than 1 L, between 0.1 and 2 L, or any size in between.

Item 5. The system of item 1, wherein said small-scale mixer has a fill volume of about 100 L, about 50 L, about 10 L, about 5 L, about 2 L, about 1.5 L, about 1 L, about 0.1 L, or any size in between.

Item 6. The system of item 1, further comprising a first computer system coupled to the at least one three-dimensional printer, the first computer system configured to store at least one three-dimensional model of said components of said small-scale mixer and to communicate said at least one three-dimensional model to said three-dimensional printers.

Item 7. The system of item 6, further comprising a second computer system coupled to the first computer system, the second computer system configured to generate said at least one three-dimensional model.

Item 8. The system of item 7, wherein generating said at least one three-dimensional model uses a scaling factor relating a plurality of dimensions of said at least one three-dimensional model to a plurality of dimensions of a second mixer.

Item 9. The system of item 8, wherein said plurality of dimensions comprises tank width, tank depth, impeller clearance off the bottom of the mixer, liquid level, tank diameter, baffle width, impeller diameter, hub diameter, blade width, blade height, and hub height.

Item 10. The system of item 2, wherein said first three-dimensional printer is configured to produce a shell of said small-scale mixer using a material selected from the group consisting of polycarbonate, acrylonitrile butadiene styrene, polylactic acid, polyethylene terephthalate (PET), nylon, metal, and glass/PET.

Item 11. The system of item 2, wherein said first three-dimensional printer is configured to use fusion deposition modeling.

Item 12. The system of item 2, wherein said first three-dimensional printer is configured to eject material in liquid or semi-liquid form in order to deposit it in successive layers using a nozzle.

Item 13. The system of item 12, wherein said nozzle has a diameter, or opening in the nozzle, of about 50 μm, about 100 μm, about 400 μm, or about 1,000 μm.

Item 14. The system of item 13, wherein said diameter of said nozzle results in an extrusion width of about 50 μm, about 100 μm, about 400 μm, or about 1,000 μm.

Item 15. The system of item 2, wherein said second three-dimensional printer is configured to produce an impeller or components thereof of said small-scale mixer using material selected from the group consisting of photosensitive resin, biocompatible resin with minimal leachables and extractables, and low absorption engineering resin.

Item 16. The system of item 15, wherein said photosensitive resin is dental resin.

Item 17. The system of item 15, wherein said impeller components include a bearing clip, pin restraint, top fin section, bottom hub of the impeller, and magnets.

Item 18. The system of item 2, wherein said second three-dimensional printer is configured to produce an impeller configured with magnet configurations.

Item 19. The system of item 2, wherein said second three-dimensional printer comprises an ultraviolet liquid crystal display screen.

Item 20. The system of item 2, wherein said second three-dimensional printer is configured to print at a resolution in the x and y axes of about 5 μm, about 10 μm, about 20 μm, about 30 μm, about 40 μm, about 50 μm, about 60 μm, about 70 μm, about 80 μm, about 90 μm, about 100 μm, or any length in between.

Item 21. The system of item 2, wherein said second three-dimensional printer is configured to print at a resolution in the z axis that is about 0.05×, about 0.1×, about 0.2×, about 0.3×, about 0.4×, about 0.5×, about 0.6×, about 0.7×, about 0.8×, about 0.9×, about 1.0×, about 2.0×, about 3.0×, about 4.0×, about 5.0×, about 6.0×, about 7.0×, about 8.0×, about 9.0×, about 10.0×, or about 20.0× the resolution in the x and y axes, or any resolution in between.

Item 22. The system of item 1, wherein said at least one smoothing apparatus is configured to smooth a surface of said components of said small-scale mixer using material selected from the group consisting of photosensitive resin, biocompatible resin with minimal leachables and extractables, and low absorption engineering resin.

Item 23. The system of item 22, wherein said photosensitive resin is dental resin.

Item 24. The system of item 1, wherein said at least one smoothing apparatus is configured to smooth a surface of said small-scale mixer by curing at least one layer of said material coated on said surface.

Item 25. The system of item 1, wherein said at least one smoothing apparatus comprises a handheld ultraviolet (UV) light, curing chamber or a photostability UV chamber.

Item 26. The system of item 1, wherein said at least one smoothing apparatus is configured to chemically smooth a surface of said small-scale mixer using a volatile solvent bath.

Item 27. The system of item 1, wherein said at least one smoothing apparatus comprises chemically polishing a surface of said small-scale mixer using a volatile solvent.

Item 28. The system of item 1, wherein said at least one smoothing apparatus is configured to melt a material of said second mixer onto a surface of said small-scale mixer using a heat gun.

Item 29. The system of item 28, wherein said material of said second mixer is a linear low density polyethylene.

Item 30. The system of item 1, wherein said at least one smoothing apparatus comprises physical abrasion.

Item 31. The system of item 30, wherein said at least one smoothing apparatus can be sand paper, polishing paper, polishing power, polishing paste, and/or sand blasting.

Item 32. The system of item 1, wherein said fusing is performed by resin curing.

Item 33. The system of item 1, wherein said fusing apparatus is a handheld UV light, curing chamber, or a UV photostability chamber.

Item 34. The system of item 1, wherein said at least one smoothing apparatus is the same apparatus as said fusing apparatus.

Item 35. The system of item 1, wherein said second mixer can be a LevMixer® Single-Use Mixing Systems by Pall Life Sciences, a Flexsafe® Single-Use Mixing Systems by Sartorius, or a Mobius® Single-Use Mixing Systems by Merck KGaA.

Item 36. The system of item 1, wherein said second mixer has a fill volume of greater than 10 L, greater than 50 L, greater than 100 L, greater than 200 L, or greater than 500 L, greater than 1,000 L, greater than 2,000 L, greater than 5,000 L, greater than 10,000 L, or greater than 50,000 L, or any size in between.

Item 37. The system of item 1, wherein said second mixer has a fill volume of about 10 L, about 50 L, about 100 L, about 200 L, about 500 L, about 1,000 L, about 2,000 L, about 5,000 L, about 10,000 L, about 50,000 L, or any size in between.

Item 38. A method of producing a small-scale mixer that replicates mixing operations of a second mixer, comprising:
(a) selecting a fill volume for a small-scale mixer;
(b) obtaining dimensions of a second mixer, wherein said second mixer has a larger fill volume than said selected fill volume;
(c) comparing said fill volume of said small-scale mixer to said fill volume of said second mixer to determine a scaling factor;
(d) applying said scaling factor to a plurality of dimensions of said second mixer to determine a corresponding plurality of dimensions of said small-scale mixer;
(e) using said plurality of dimensions of said small-scale mixer to generate at least one three-dimensional model of said small-scale mixer or components thereof;
(f) using said at least one three-dimensional model to produce a small-scale mixer shell having a first quality attribute, said producing comprising:
   (i) communicating said at least one three-dimensional model to a three-dimensional printer to print said small-scale mixer shell; and
   (ii) subjecting said small-scale mixer shell to smoothing to produce a smoothed small-scale mixer shell;
(g) using said at least one three-dimensional model to produce a small-scale mixer impeller having a second quality attribute, said producing comprising:
   (i) communicating said at least one three-dimensional model to a three-dimensional printer to print components of said small-scale mixer impeller;
   (ii) subjecting said components of said small-scale mixer impeller to fusion to produce a fused small-scale mixer impeller; and
   (iii) subjecting said fused small-scale mixer impeller to smoothing to produce a smoothed small-scale mixer impeller; and
(h) subjecting said smoothed small-scale mixer shell and said smoothed small-scale mixer impeller to fusion to produce said small-scale mixer.

Item 39. The method of item 38, wherein said printing of said small-scale mixer shell uses a first three-dimensional printer and said printing of components of said small-scale mixer impeller uses a second three-dimensional printer.

Item 40. The method of item 38, wherein said first and second quality attribute includes precision, size, density, surface roughness, and thickness.

Item 41. The method of item 38, wherein said plurality of dimensions of said small-scale mixer and said plurality of dimensions of said second mixer comprise tank width, tank depth, impeller clearance off the bottom of the mixer, liquid level, tank diameter, baffle width, impeller diameter, hub diameter, blade width, blade height, and/or hub height.

Item 42. The method of item 39, wherein said first three-dimensional printer uses a material selected from the group consisting of polycarbonate, acrylonitrile butadiene styrene, polylactic acid, polyethylene terephthalate (PET), nylon, metal, and glass/PET.

Item 43. The method of item 39, wherein said first three-dimensional printer ejects material in liquid or semi-liquid form in order to deposit it in successive layers using a nozzle.

Item 44. The method of item 43, wherein said nozzle has a diameter, or opening in the nozzle, of about 50 μm, about 100 μm, about 400 μm, or about 1,000 μm.

Item 45. The method of item 44, wherein said diameter of said nozzle results in an extrusion width of about 50 μm, about 100 μm, about 400 μm, or about 1,000 μm.

Item 46. The method of item 39, wherein said second three-dimensional printer uses a material selected from the group consisting of photosensitive resin, biocompatible resin with minimal leachables and extractables, and low absorption engineering resin.

Item 47. The method of item 46, wherein said photosensitive resin is dental resin.

Item 48. The method of item 39, wherein said second three-dimensional printer comprises an ultraviolet liquid crystal display.

Item 49. The method of item 39, wherein said second three-dimensional printer prints at a resolution in the x and y axis of about 5 μm, about 10 μm, about 20 μm, about 25 μm, about 30 μm, about 45 μm, about 50 μm, about 60 μm, about 70 μm, about 80 μm, about 90 μm or about 100 μm, or any length in between.

Item 50. The method of item 39, wherein said second three-dimensional printer is configured to print at a resolution in the z axis that is about 0.05×, about 0.1×, about 0.2×, about 0.3×, about 0.4×, about 0.5×, about 0.6×, about 0.7×, about 0.8×, about 0.9×, about 1.0×, about 2.0×, about 3.0×, about 4.0×, about 5.0×, about 6.0×, about 7.0×, about 8.0×, about 9.0×, about 10.0×, or about 20.0× the resolution in the x and y axes, or any resolution in between.

Item 51. The method of item 38, wherein said components of said small-scale mixer impeller comprise a bearing clip, pin restraint, top fin section, bottom hub of the impeller, and magnets.

Item 52. The method of item 38, wherein said small-scale mixer impeller comprises a magnet configuration.

Item 53. The method of item 38, wherein said smoothing of step (f) (ii) and/or said smoothing of step (g) (iii) comprises coating a surface of said small-scale mixer components with a material selected from the group consisting of photosensitive resin, biocompatible resin with minimal leachables and extractables, and low absorption engineering resin.

Item 54. The method of item 53, wherein said photosensitive resin is dental resin.

Item 55. The method of item 53, wherein a number of layers of said material is about 2, about 3, about 4, or about 5.

Item 56. The method of item 53, wherein said smoothing further comprises curing said surface of said small-scale mixer components coated with said material.

Item 57. The method of item 56, wherein said curing is performed using a handheld UV light, a curing chamber or a UV photostability chamber.

Item 58. The method of item 38, wherein said smoothing comprises chemically polishing a surface of said small-scale mixer using a volatile solvent.

Item 59. The method of item 38, wherein said smoothing comprises melting a material of said second mixer onto a surface of said small-scale mixer using a heat gun.

Item 60. The method of item 59, wherein said material of said second mixer is a linear low density polyethylene.

Item 61. The method of item 38, wherein said smoothing comprises physically polishing a surface of said small-scale mixer using a sand paper, polishing paper, polishing powder, polishing paste, and/or sand blasting.

Item 62. The method of item 38, wherein said fusion of step (g) (ii) and/or said fusion of step (h) comprises use of a material selected from the group consisting of photosensitive resin, biocompatible resin with minimal leachables and extractables, and low absorption engineering resin.

Item 63. The method of item 62, wherein said photosensitive resin is dental resin.

Item 64. The method of item 62, wherein said fusion is performed using a handheld UV light, curing chamber or a photostability UV chamber.

Item 65. The method of item 38, further comprising attaching a bearing holder to the bottom of said small-scale mixer impeller prior to step (h).

Item 66. The method of item 38, wherein said fill volume of said small-scale mixer is less than 100 L, less than 50 L, less than 10 L, less than 5 L, less than 3 L, less than 2 L, less than 1 L, between 0.1 and 2 L, or any size in between.

Item 67. The method of item 38, wherein said fill volume of said small-scale mixer is about 50 L, about 10 L, about 5 L, about 2 L, about 1.5 L, about 1 L, about 0.1 L, or any size in between.

Item 68. The method of item 38, wherein said fill volume of said second mixer is greater than 10 L, greater than 50 L, greater than 100 L, greater than 200 L, or greater than 500 L, greater than 1,000 L, greater than 2,000 L, greater than 5,000 L, greater than 10,000 L, greater than 50,000 L, or any size in between.

Item 69. The method of item 38, wherein said fill volume of said second mixer is about 10 L, about 50 L, about 100 L, about 200 L, about 500 L, about 1,000 L, about 2,000 L, about 5,000 L, about 10,000 L, about 50,000 L, or any size in between.

Item 70. The method of item 38, wherein said scaling factor is from about 0.1 to about 0.5, about 0.1, about 0.2, about 0.3, about 0.4, or about 0.5.

Item 71. The method of item 38, wherein said scaling factor is about 0.16.

Item 72. The method of item 38, further comprising validating said small-scale mixer by:
(a) dividing a sample including a protein into a first sample and a second sample;
(b) subjecting said first sample to mixing using said small-scale mixer to produce a first mixed sample;
(c) subjecting said second sample to mixing using said second mixer to produce a second mixed sample; and
(d) comparing one or more physical parameters of said first mixed sample and said second mixed sample to validate said small-scale mixer,
wherein said small-scale mixer and said second mixer are operated at substantially the same mixing parameter.

Item 73. The method of item 72, wherein said mixing parameter includes Reynolds, wall shear, vorticity, residence time distribution (RTD), rotations per minute (RPM), and/or tip speed.

Item 74. The method of item 72, further comprising comparing the shear stress of generating said first mixed sample with the shear stress of generating said second mixed sample.

Item 75. The method of item 72, wherein said one or more physical parameters include one or more of visual inspection, pH, protein concentration, density, turbidity, purity, and particle density.

Item 76. The method of item 72, further comprising obtaining a first mixed sample and a second mixed sample at each of more than one time points.

Item 77. A system for producing a small-scale mixer that replicates mixing operations of a second mixer, comprising:
at least one three-dimensional (3D) printer operable to produce a first and second set of predetermined components with a respective first attribute and second attribute of the small-scale mixer that replicate operation of corresponding components of the second mixer;
at least one smoothing apparatus configured to smooth a surface of the components of the small-scale mixer produced by the at least one 3D printer; and
a fusing apparatus configured to fuse the smoothed components of the small-scale mixer to produce the small-scale mixer.

Item 78. The system of item 77, wherein the at least one 3D printer comprises a first 3D printer and a second 3D printer.

Item 79. The system of item 77, wherein the respective first attribute and second attribute of the small-scale mixer includes precision, size, density, surface roughness, and thickness.

Item 80. The system of item 77, wherein the small-scale mixer has a fill volume of about 50 L or less.

Item 81. The system of item 77, further comprising:
a first computer system coupled to the at least one 3D printer, the first computer system configured to store at least one 3D model of the components of the small-scale mixer and to communicate the at least one 3D model to said at least one 3D printer; and
a second computer system coupled to the first computer system, the second computer system configured to generate said at least one 3D model,
wherein generating said at least one 3D model uses a scaling factor relating a plurality of dimensions of said at least one 3D model to a plurality of dimensions of a second mixer.

Item 82. The system of item 81, wherein the plurality of dimensions comprises one or more of tank width, tank depth, impeller clearance off the bottom of the mixer, liquid level, tank diameter, baffle width, impeller diameter, hub diameter, blade width, blade height, and hub height.

Item 83. The system of item 77, wherein the fusing apparatus is configured to fuse by performing resin curing, and wherein the fusing apparatus comprises a handheld UV light, curing chamber, or a UV photostability chamber.

Item 84. The system of item 77, wherein the at least one smoothing apparatus is configured to chemically smooth a surface of the small-scale mixer using a volatile solvent bath.

Item 85. The system of item 77, wherein the at least one smoothing apparatus is configured to smooth a surface of the small-scale mixer by melting a material of the second mixer onto the surface of the small-scale mixer using a heat gun.

Item 86. The system of item 77, wherein the at least one smoothing apparatus is configured to smooth a surface of the small-scale mixer by physical abrasion, and wherein the at least one smoothing apparatus comprises sand paper, polishing paper, polishing power, polishing paste, and/or sand blasting.

Item 87. A system for producing a small-scale mixer that replicates mixing operations of a second mixer, comprising:
at least one three-dimensional (3D) printer operable to produce a first and second set of predetermined components with a respective first attribute and second attribute of the small-scale mixer that replicate operation of corresponding components of the second mixer;
at least one smoothing apparatus configured to smooth a surface of the components of the small-scale mixer produced by the at least one 3D printer; and
a fusing apparatus configured to fuse the smoothed components of the small-scale mixer to produce the small-scale mixer.

Item 88. The system of item 87, wherein the at least one 3D printer comprises a first 3D printer and a second 3D printer.

Item 89. The system of item 87, wherein the respective first attribute and second attribute of the small-scale mixer include one or more of: precision, size, density, surface roughness, and thickness.

Item 90. The system of item 87, wherein the small-scale mixer has a fill volume of about 50 L or less.

Item 91. The system of item 87, further comprising:
a first computer system coupled to the at least one 3D printer, the first computer system configured to store at least one 3D model of the components of the small-scale mixer and to communicate the at least one 3D model to the at least one 3D printer; and
a second computer system coupled to the first computer system, the second computer system configured to generate the at least one 3D model,
wherein generating the at least one 3D model uses a scaling factor relating a plurality of dimensions of the at least one 3D model to a plurality of dimensions of a second mixer.

Item 92. The system of item 91, wherein the plurality of dimensions comprises one or more of tank width, tank depth, impeller clearance off of a bottom of the mixer, liquid level, tank diameter, baffle width, impeller diameter, hub diameter, blade width, blade height, and hub height.

Item 93. The system of item 87, wherein the fusing apparatus is configured to fuse by performing resin curing, and wherein the fusing apparatus comprises a handheld UV light, curing chamber, or a UV photostability chamber.

Item 94. The system of item 87, wherein the at least one smoothing apparatus is configured to chemically smooth a surface of the small-scale mixer using a volatile solvent bath.

Item 95. The system of item 87, wherein the at least one smoothing apparatus is configured to smooth a surface of the small-scale mixer by melting a material of the second mixer onto the surface of the small-scale mixer using a heat gun.

Item 96. The system of item 87, wherein the at least one smoothing apparatus is configured to smooth a surface of the small-scale mixer by physical abrasion, and wherein the at least one smoothing apparatus comprises one or more of: sand paper, polishing paper, polishing powder, polishing paste, and sand blasting.

Item 97. A system for producing a small-scale mixer that replicates mixing operations of a second mixer, comprising:
at least one three-dimensional (3D) printer operable to produce a first and second set of predetermined components with a respective first attribute and second attribute of the small-scale mixer that replicate operation of corresponding components of the second mixer, wherein the at least one 3D printer comprises a first 3D printer and a second 3D printer;
at least one smoothing apparatus configured to smooth a surface of the components of the small-scale mixer produced by the at least one 3D printer; and
a fusing apparatus configured to fuse the smoothed components of the small-scale mixer to produce the small-scale mixer.

Item 98. The system of item 97, wherein the first 3D printer is configured to produce a shell of the small-scale mixer using a material selected from the group consisting of polycarbonate, acrylonitrile butadiene styrene, polylactic acid, polyethylene terephthalate (PET), nylon, metal, and glass/PET.

Item 99. The system of item 97, wherein the first 3D printer is configured to use fusion deposition modeling.

Item 100. The system of item 97, wherein the second 3D printer is configured to produce an impeller or components thereof of the small-scale mixer using material selected from the group consisting of photosensitive resin, biocompatible resin with minimal leachables and extractables, and low absorption engineering resin.

Item 101. The system of item 100, wherein the photosensitive resin is dental resin.

Item 102. The system of item 100, wherein the impeller components include a bearing clip, pin restraint, top fin section, bottom hub of the impeller, and magnets.

Item 103. The system of item 97, wherein the second 3D printer is configured to print at a resolution in an x-axis and a y-axis of about 5 μm to about 100 μm.

Item 104. The system of item 97, wherein the second 3D printer is configured to print at a resolution in a z-axis of about 0.05× to about 20.0× of the resolution in an x-axis and a y-axis.

Item 105. A system for producing a small-scale mixer that replicates mixing operations of a second mixer, comprising:
at least one three-dimensional (3D) printer operable to produce a first and second set of predetermined components with a respective first attribute and second attribute of the small-scale mixer that replicate operation of corresponding components of the second mixer;
at least one smoothing apparatus configured to smooth a surface of the components of the small-scale mixer produced by the at least one 3D printer, wherein the at least one smoothing apparatus is configured to smooth the by:
   applying at least one layer of a material to the surface, wherein the material is selected from the group consisting of photosensitive resin, biocompatible resin with minimal leachables and extractables, and low absorption engineering resin; and
   curing the at least one layer of material on the surface; and a fusing apparatus configured to fuse the smoothed components of the small-scale mixer to produce the small-scale mixer.

Item 106. The system of item 105, wherein the photosensitive resin is dental resin.

What is claimed is:

1. A system for producing a small-scale mixer that replicates mixing operations of a second mixer, comprising:
at least one three-dimensional (3D) printer operable to produce a first and second set of predetermined components with a respective first attribute and second attribute of the small-scale mixer that replicate operation of corresponding components of the second mixer;
at least one smoothing apparatus configured to smooth a surface of the components of the small-scale mixer produced by the at least one 3D printer; and
a fusing apparatus configured to fuse the smoothed components of the small-scale mixer to produce the small-scale mixer.

2. The system of claim 1, wherein the at least one 3D printer comprises a first 3D printer and a second 3D printer.

3. The system of claim 1, wherein the respective first attribute and second attribute of the small-scale mixer include one or more of: precision, size, density, surface roughness, and thickness.

4. The system of claim 1, wherein the small-scale mixer has a fill volume of about 50 L or less.

5. The system of claim 1, further comprising:
a first computer system coupled to the at least one 3D printer, the first computer system configured to store at least one 3D model of the components of the small-scale mixer and to communicate the at least one 3D model to the at least one 3D printer; and
a second computer system coupled to the first computer system, the second computer system configured to generate the at least one 3D model,
wherein generating the at least one 3D model uses a scaling factor relating a plurality of dimensions of the at least one 3D model to a plurality of dimensions of a second mixer.

6. The system of claim 5, wherein the plurality of dimensions comprises one or more of tank width, tank depth, impeller clearance off of a bottom of the mixer, liquid level, tank diameter, baffle width, impeller diameter, hub diameter, blade width, blade height, and hub height.

7. The system of claim 1, wherein the fusing apparatus is configured to fuse by performing resin curing, and wherein the fusing apparatus comprises a handheld UV light, curing chamber, or a UV photostability chamber.

8. The system of claim 1, wherein the at least one smoothing apparatus is configured to chemically smooth a surface of the small-scale mixer using a volatile solvent bath.

9. The system of claim 1, wherein the at least one smoothing apparatus is configured to smooth a surface of the small-scale mixer by melting a material of the second mixer onto the surface of the small-scale mixer using a heat gun.

10. The system of claim 1, wherein the at least one smoothing apparatus is configured to smooth a surface of the small-scale mixer by physical abrasion, and wherein the at least one smoothing apparatus comprises one or more of: sand paper, polishing paper, polishing powder, polishing paste, and sand blasting.

11. A system for producing a small-scale mixer that replicates mixing operations of a second mixer, comprising:
at least one three-dimensional (3D) printer operable to produce a first and second set of predetermined components with a respective first attribute and second attribute of the small-scale mixer that replicate operation of corresponding components of the second mixer, wherein the at least one 3D printer comprises a first 3D printer and a second 3D printer;
at least one smoothing apparatus configured to smooth a surface of the components of the small-scale mixer produced by the at least one 3D printer; and
a fusing apparatus configured to fuse the smoothed components of the small-scale mixer to produce the small-scale mixer.

12. The system of claim 11, wherein the first 3D printer is configured to produce a shell of the small-scale mixer using a material selected from the group consisting of polycarbonate, acrylonitrile butadiene styrene, polylactic acid, polyethylene terephthalate (PET), nylon, metal, and glass/PET.

13. The system of claim 11, wherein the first 3D printer is configured to use fusion deposition modeling.

14. The system of claim 11, wherein the second 3D printer is configured to produce an impeller or components thereof of the small-scale mixer using material selected from the group consisting of photosensitive resin, biocompatible resin with minimal leachables and extractables, and low absorption engineering resin.

15. The system of claim 14, wherein the photosensitive resin is dental resin.

16. The system of claim 14, wherein the impeller components include a bearing clip, pin restraint, top fin section, bottom hub of the impeller, and magnets.

17. The system of claim 11, wherein the second 3D printer is configured to print at a resolution in an x-axis and a y-axis of about 5 μm to about 100 μm.

18. The system of claim 11, wherein the second 3D printer is configured to print at a resolution in a z-axis of about 0.05× to about 20.0× of the resolution in an x-axis and a y-axis.

19. A system for producing a small-scale mixer that replicates mixing operations of a second mixer, comprising:
at least one three-dimensional (3D) printer operable to produce a first and second set of predetermined components with a respective first attribute and second attribute of the small-scale mixer that replicate operation of corresponding components of the second mixer;
at least one smoothing apparatus configured to smooth a surface of the components of the small-scale mixer produced by the at least one 3D printer, wherein the at least one smoothing apparatus is configured to smooth the by:
applying at least one layer of a material to the surface, wherein the material is selected from the group consisting of photosensitive resin, biocompatible resin with minimal leachables and extractables, and low absorption engineering resin; and
curing the at least one layer of material on the surface; and
a fusing apparatus configured to fuse the smoothed components of the small-scale mixer to produce the small-scale mixer.

20. The system of claim 19, wherein the photosensitive resin is dental resin.
